(19) United States
(12) Patent Application Publication
(10) Pub. No.: US 2006/0270808 A1
(43) Pub. Date: Nov. 30, 2006

(54) Epoxy-silicone mixed resin composition, cured article thereof, and light-emitting semiconductor device

(75) Inventors: Katsuyuki Imazawa, Annaka-shi (JP); Tsutomu Kashiwagi, Annaka-shi (JP); Tokue Kojima, Annaka-shi (JP); Toshio Shiobara, Annaka-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/438,444

(22) Filed: May 23, 2006

(30) Foreign Application Priority Data
May 24, 2005 (JP) 2005-151200

(51) Int. Cl. C08L 83/05; C08L 63/00

(52) U.S. Cl. 525/476; 525/478

(57) ABSTRACT

An epoxy-silicone mixed resin composition comprising (A) an organopolysiloxane having at least one vinyl or allyl group and at least one hydroxyl group, (B) an organic resin having at least one epoxy group, (C) an organohydrogenpolysiloxane, (D) a platinum group metal-based catalyst, (E) an aluminum compound, and (F) 0.1-15% by weight of an organic mold release agent is molded and cured in a metal mold into a transparent product which can be smoothly removed from the mold. The cured product has a satisfactory bond strength to metal frames and maintains heat resistance. LED devices can be fabricated by continuous mechanical molding.

### CROSS-REFERENCE TO RELATED APPLICATION

This non-provisional application claims priority under 35 U.S.C. §119(a) on Patent Application No. 2005-151200 filed in Japan on May 24, 2005, the entire contents of which are hereby incorporated by reference.

### TECHNICAL FIELD

This invention relates to epoxy-silicone mixed resin compositions which are improved in molding and mold release properties and enable their use to be extended to mechanical molding applications including injection molding, cured articles thereof, and light-emitting semiconductor devices encapsulated therewith.

### BACKGROUND ART

Lenses for use in light-emitting diode (LED) devices are mass manufactured by mechanical molding such as injection molding. Although prior art lenses are molded using thermoplastic resins such as acrylic resins and polycarbonate resins, the currently increasing power of LED devices invites the problem that thermoplastic resins' heat resistance and discoloration resistance are short.

In traditional light-emitting semiconductor devices such as light-emitting diodes (LED), a light-emitting semiconductor member (or LED chip) 1 is disposed on a metal frame 4 and electrically connected via a conductive wire 2 as shown in FIG. 1. There is a demand for mechanically molding an encapsulating resin composition 3 directly over the chip 1. Commonly used to this end are resin compositions comprising an epoxy resin such as a bisphenol A epoxy resin or alicyclic epoxy resin and an acid anhydride curing agent (see Japanese Patent No. 3,241,338 corresponding to JP-A 11-274571 and JP-A 7-025987). However, these transparent epoxy resins have drawbacks including poor durability to moisture due to a high percent water absorption, poor durability to light due to a low transmittance of short wavelength light, and coloring as a result of photo-degradation.

Under the circumstances, resin compositions comprising an organic compound having at least two carbon-to-carbon double bonds (which are reactive with SiH groups) in a molecule, a silicon compound having at least two SiH groups in a molecule, and a hydrosilylating catalyst were proposed for the embedment and protection of optical semiconductor members (see JP-A 2002-327126 and JP-A 2002-338833). Regrettably, such silicone compositions have a drawback that when an attempt is made to improve the crack resistance, the cured composition retains surface tack so that dust readily deposits on the surface to interfere with light transmission.

It was then proposed to use high-hardness silicone resins for the embedment and protection purposes (see JP-A 2002-314139 corresponding to U.S. Pat. No. 6,614,172 and JP-A 2002-314143 corresponding to US 2002-0145152 A). The high-hardness silicone resins, however, are less adhesive. In an encased light-emitting semiconductor device comprising a light-emitting member disposed in a ceramic and/or plastic housing, wherein the housing interior is filled with a silicone resin, a problem arises in a thermal shock test between −40° C. and 120° C., that the silicone resin separates from the ceramic or plastic housing.

A molding composition comprising epoxy and silicone components as disclosed in JP-A 52-107049 corresponding to U.S. Pat. No. 4,082,719 appears to overcome the above drawbacks, but suffers from adhesion and discoloration problems. Another problem arises from the fact that optical crystals of various compound semiconductors used in light-emitting members, such as SiC, GaAs, GaP, GaAsP, GaAlAs, InAlGaP, InGaN, and GaN, have high refractive indices. If the refractive index of embedding/protecting resin is low as in the case of dimethylsilicone resin, light is reflected at the interface between the embedding resin and the optical crystal, resulting in a lower emission efficiency.

It was then proposed to add an antireflective film as a means of enhancing the outcoupling efficiency (see JP-A 2001-217467 corresponding to US 2002-0190262 A). The provision of an antireflective film undesirably adds to preparatory steps and increases the cost.

While a number of resin compositions for LED devices have been proposed in the art as discussed above, many compositions suffer from the adhesion problem. Some other compositions are formulated to improve adhesion, but when processed in metal molds by injection molding, transfer molding or compression molding, they are difficult to remove from the metal molds.

### DISCLOSURE OF THE INVENTION

An object of the invention is to provide an epoxy-silicone mixed resin composition which has both improved adhesion to metal frames and improved release from metal molds, a cured article thereof, and a light-emitting semiconductor device encapsulated therewith.

The inventors have found that the above and other objects are attained by forming an epoxy-silicone mixed resin composition comprising (A) an organopolysiloxane having at least one vinyl or allyl group and at least one hydroxyl group per molecule, (B) an organic resin having at least one epoxy group per molecule, (C) an organohydrogenpolysiloxane, (D) a platinum group metal-based catalyst, and (E) an aluminum compound, and adding (F) an organic mold release agent thereto, preferably in an amount of 0.1 to 15% by weight.

The inventors proposed in U.S. Ser. No. 10/990,959 (US 2005-0129957 corresponding to JP-A 2005-158766) an epoxy-silicone mixed resin composition which is surface tack-free and has improved adhesion, impact resistance, and light transmittance and is suitable as light-emitting semiconductor encapsulant, the composition comprising as essential components, (A′) an organosilicon compound containing at least one aliphatic unsaturated monovalent hydrocarbon group and at least one silicon atom-bonded hydroxyl group per molecule, (B) an epoxy resin containing at least one epoxy group per molecule, (C) an organohydrogenpolysiloxane, (D) a platinum group metal-based catalyst, and (E) an aluminum-based curing catalyst, wherein hydrosilylation reaction and curing reaction of the epoxy resin coexist. However, when this epoxy-silicone mixed resin composition is mechanically molded in a metal mold, its removal from the metal mold is impeded by the improved adhesion. Sometimes, satisfactory molded parts are not obtained. To provide for smooth removal from the metal mold, mold release agents may be directly applied to the metal mold by spraying or the like. The step of spraying the release agent is not so desirable in view of productivity. In addition, the surface of molded parts is altered by the transfer of the release agent to the molded parts. This is one of factors that detract from transparency.

Thus there is a need for an epoxy-containing silicone resin composition which possesses a pair of contradictory properties, that is, improved adhesion to metal frames and improved removal from metal molds. As indicated above, this problem is solved by compounding an organic mold release agent, specifically a fatty acid-derived mold release agent.

In one aspect, the present invention provides an epoxy-silicone mixed resin composition comprising as essential components,

(A) an organopolysiloxane having at least one vinyl or allyl group and at least one hydroxyl group per molecule,

(B) an organic resin having at least one epoxy group per molecule,

(C) an organohydrogenpolysiloxane,

(D) a platinum group metal-based catalyst,

(E) an aluminum compound, and

(F) an organic mold release agent, the composition becoming transparent when cured.

The organic mold release agent is typically a fatty acid derivative and is preferably present in an amount of 0.1 to 15% by weight based on the total weight of the composition. The composition is typically used in injection molding, transfer molding or compression molding in a metal mold.

Also contemplated herein are a transparent article obtained by curing the epoxy-silicone mixed resin composition, and a light-emitting semiconductor device in which a light-emitting semiconductor member is encapsulated with the cured product.

As used herein, the term “encapsulation” refers to embedding, sealing, coating and protecting functions and is interchangeable therewith.

### BENEFITS OF THE INVENTION

The epoxy-silicone mixed resin composition of the invention to which an organic mold release agent is added, preferably in an amount of 0.1 to 15% by weight, exhibits improved removal from a metal mold in a mechanical molding process. Then LED devices can be manufactured by continuous mechanical molding. At the same time, the composition has improved adhesion to metal frames and maintains heat resistance.

### BRIEF DESCRIPTION OF THE DRAWINGS

FIG. 1 is a schematic cross section of an exemplary light-emitting semiconductor device of the invention.

FIG. 2 is a graph showing metal mold adhesion versus release agent concentration.

FIG. 3 is a graph showing metal frame adhesion versus release agent concentration.

FIG. 4 is a schematic cross section of an exemplary surface mounting light-emitting semiconductor device in which a light-emitting member is die-bonded to an insulating housing.

FIG. 5 is a schematic cross section of another exemplary surface mounting light-emitting semiconductor device in which a light-emitting member is die-bonded to lead electrodes inserted through a housing.

FIG. 6 is a schematic cross section of an LED as a lamp type light-emitting semiconductor device.

### DESCRIPTION OF THE PREFERRED EMBODIMENT

In one embodiment of the invention, the epoxy-containing silicone resin composition (i.e., epoxy-silicone mixed resin composition) comprises components (A) to (F) as defined above. Components (A) and (B) constitute a base polymer of the composition. Component (D) catalyzes hydrosilylation reaction of components (A) and (C) whereby cure occurs. At the same time, component (E) catalyzes ring-opening polymerization of oxirane ring to induce crosslinking between components (A) and (B) for curing.

(A) Organopolysiloxane

Component (A) is an organopolysiloxane containing at least one vinyl or allyl group and at least one hydroxyl group per molecule. Preferred are those polysiloxanes containing at least one aliphatic unsaturated group and at least one OH group per molecule wherein a vinyl group is attached to a silicon atom at an end of a molecular chain, especially each end thereof, as represented by the average compositional formula (1):
(R¹)ₐ(R²)_{b}(HO)_{c}SiO_{(4-a-b-c)/2} (1)
wherein R¹ is each independently a substituted or unsubstituted monovalent hydrocarbon group having aliphatic unsaturation, R² is each independently a substituted or unsubstituted monovalent hydrocarbon group free of aliphatic unsaturation, the subscripts a and c each are a positive number, b is 0 or a positive number, satisfying a+b+c<4.

Specifically, preferred hydrocarbon groups of R¹ include those of 2 to 10 carbon atoms, more preferably 2 to 6 carbon atoms, typically alkenyl groups such as vinyl, allyl, propenyl, isopropenyl and butenyl, acryloxy and methacryloxy. Preferred hydrocarbon groups of R² include those of 1 to 10 carbon atoms, more preferably 1 to 6 carbon atoms, typically alkyl groups such as methyl, ethyl, propyl, butyl and cyclohexyl, aryl groups such as phenyl and tolyl, and aralkyl groups such as benzyl.

The organopolysiloxane may include siloxane units selected from among (CH₃)₂(OH)SiO_{1/2}, (CH₃)₂SiO, CH₃(C₆H₅)(OH)SiO_{1/2}, CH₃SiO_{3/2}, CH₃(C₆H₅)SiO, C₃H₇(CH₃)SiO, (CH₂═CH)(C₆H₅)(OH)SiO_{1/2}, C₆H₅(CH₂═CH)(CH₃)SiO_{1/2}, (CH₂═CH)(CH₃)SiO, C₆H₅(OH)SiO, (C₆H₅)₂SiO, and C₆H₅(CH₃)₂SiO_{1/2} units, and combinations thereof, while a minor amount of SiO₂ units may be included. An organopolysiloxane of this type can be readily prepared by hydrolysis of an organochlorosilane corresponding to a selected siloxane unit, followed by condensation of hydroxyl groups for achieving polymerization with a necessary amount of hydroxyl groups being left behind.

The subscripts a, b and c are preferably such numbers as to satisfy: 0.001≦a≦0.5, especially 0.01≦a≦0.2; 0≦b=2.2, especially 0.5≦b≦2; and 0.001≦c≦0.5, especially 0.01≦c≦0.2. The sum of a+b+c is preferably 0.8≦a+b+c≦3, especially 1≦a+b+c≦2.5.

Illustrative preferred examples of organopolysiloxane are those of the following structural formulae.

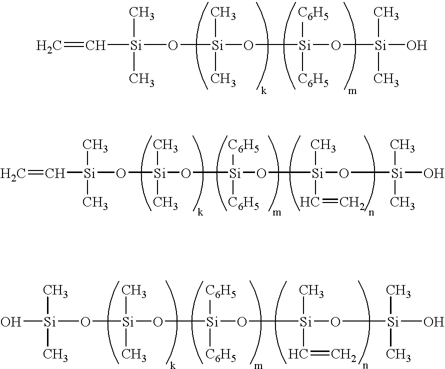

Note that k, m and n are positive numbers, and the sum of k+m+n is such a number that the organopolysiloxane may have a viscosity in the range defined below.

In an embodiment wherein the organopolysiloxane is a diorganopolysiloxane of generally linear structure, it preferably has a viscosity of about 10 to 1,000,000 mPa.s, especially about 100 to 100,000 mPa.s, as measured at 25° C. by a viscosity measurement method using a rotational viscometer of BM type. In an embodiment wherein the organopolysiloxane has a branched or three-dimensional network structure containing trifunctional siloxane units or tetrafunctional siloxane units (SiO₂) in the molecule, it preferably has a weight average molecular weight of about 500 to 100,000, especially about 1,000 to 10,000, as measured gel permeation chromatography (GPC) using polystyrene standards. Throughout the specification, the measurements of viscosity and molecular weight are as defined herein.

As indicated above, organopolysiloxanes containing silicon atom-bonded hydroxyl groups range from liquid to solid. For those organopolysiloxanes having a high degree of polymerization (corresponding to a viscosity of greater than or equal to 1,000 mPa.s or a weight average molecular weight of greater than or equal to 1,000), the content of silicon atom-bonded hydroxyl groups is preferably 0.5 to 15% by weight, more preferably 1.5 to 10% by weight. Organopolysiloxanes with a hydroxyl content of less than 0.5% by weight may be less reactive with epoxy groups whereas some organopolysiloxanes with a hydroxyl content of more than 15% by weight cannot be prepared in a consistent manner. Of these organosilicon compounds, those having aliphatic unsaturated hydrocarbon groups, typically alkenyl groups in the molecule are used as component (A).

(B) Epoxy Resin

Component (B) is an epoxy resin containing on average at least one epoxy group or oxirane ring. Included are bisphenol F epoxy resins, bisphenol A epoxy resins, phenol novolac epoxy resins, cresol novolac epoxy resins, naphthalene epoxy resins, biphenyl epoxy resins, dicyclopentadiene epoxy resins, aralkyl epoxy resins, biphenyl aralkyl epoxy resins, hydrogenated versions of the foregoing epoxy resins in which phenyl groups on the epoxy resins are hydrogenated, and alicyclic epoxy resins. The epoxy resin used is not limited to these as long as at least one epoxy group is included in the molecule. Inter alia, bisphenol A, hydrogenated bisphenol A and cresol novolac based resins are advantageously used, and preferred resins are represented by the following formulae. 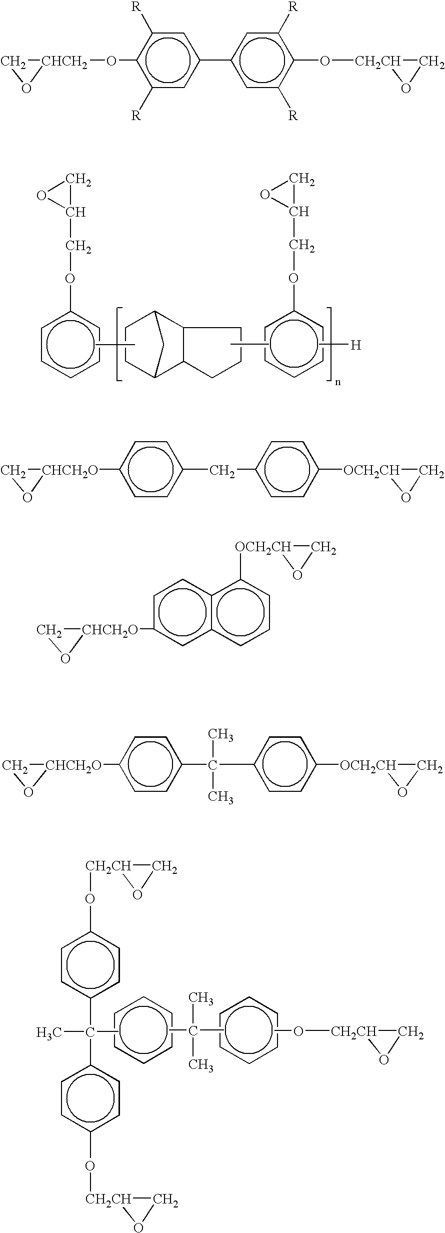 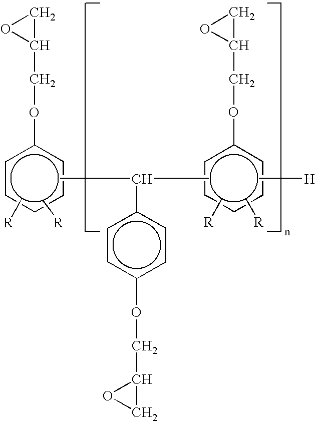
Note that R is hydrogen or alkyl such as methyl, and n is a positive number of greater than or equal to 1, typically 1 to 10, more preferably 1 to 5.

The epoxy resin is preferably present in an amount of 5 to 80% by weight based on the overall organic resins, i.e., the total weight of components (A), (B) and (C). With less than 5 wt % of the epoxy resin, the epoxy-silicone mixed resin composition may form a cured product with insufficient strength so that when a light-emitting semiconductor member is encapsulated therewith, there is a likelihood of resin cracking or adhesion failure in a thermal cycling or heat test. More than 80 wt % corresponds to a substantial proportion of epoxy resin, which suggests that when the light-emitting semiconductor member emits UV radiation, the epoxy-silicone mixed resin composition in the cured state can be degraded by the UV radiation. The more preferred proportion of the epoxy resin is 10 to 50% by weight.

(C) Organohydrogenpolysiloxane

Component (C) is an organohydrogenpolysiloxane which serves as a crosslinking agent for forming a cured product through addition reaction or hydrosilylation of SiH groups in component (C) to vinyl groups in component (A). Preferred is an organohydrogenpolysiloxane represented by the average compositional formula (2):
H_{d}(R³)ₑSiO_{(4-d-e)/2} (2)
wherein R³ is each independently a substituted or unsubstituted monovalent hydrocarbon group free of aliphatic unsaturation, d and e are numbers satisfying 0.001≦d<2, 0.7≦e≦2, and 0.8≦d+e≦3, and having at least two, more preferably at least three silicon atom-bonded hydrogen atoms (i.e., SiH groups) in a molecule.

In formula (2), R³ is each independently a substituted or unsubstituted monovalent hydrocarbon group free of aliphatic unsaturation, preferably having 1 to 10 carbon atoms, especially 1 to 7 carbon atoms, for example, lower alkyl groups such as methyl, aryl groups such as phenyl, and those exemplified above for R¹ in formula (1). The subscripts d and e are numbers satisfying 0.001≦d≦2, 0.7≦e≦2, and 0.8≦d+e≦3, preferably 0.05≦d≦1, 0.8≦e≦2, and 1≦d+e≦2.7. The position of silicon atom-bonded hydrogen atom is not critical and may be at an end or midway of the molecule.

Examples of the organohydrogenpolysiloxane include, but are not limited to, 1,1,3,3-tetramethyldisiloxane, 1,3,5,7-tetramethylcyclotetrasiloxane, methylhydrogensiloxane cyclic polymers, both end trimethylsilyl-capped methylhydrogenpolysiloxane, both end trimethylsilyl-capped dimethylsiloxanemethylhydrogensiloxane copolymers, both end dimethylhydrogensilyl-capped methylhydrogenpolysiloxane, both end dimethylhydrogensilyl-capped dimethylsiloxanemethylhydrogensiloxane copolymers, tetramethyltetrahydrogencyclotetrasiloxane, pentamethyltrihydrogencyclotetrasiloxane, tris(dimethylhydrogensiloxy)methylsilane, tris(dimethylhydrogensiloxy)phenylsilane, copolymers of H(CH₃)₂SiO_{1/2} units and SiO_{4/2} units, copolymers of H(CH₃)₂SiO_{1/2} units, (CH₃)₃SiO_{1/2} units and SiO_{4/2} units, and copolymers of H(CH₃)₂SiO_{1/2} units, (C₆H₅)₃SiO_{1/2} units and SiO_{4/2} units.

Also useful is a compound of the following structure.

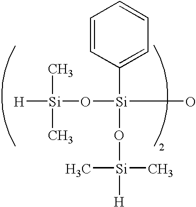

The molecular structure of the organohydrogenpolysiloxane may be either straight, branched, cyclic or three-dimensional network. The organohydrogenpolysiloxane can be obtained by hydrolysis of a chlorosilane such as R³SiHCl₂, (R³)₃SiCl, (R³)₂SiCl₂ or (R³)₂SiHCl wherein R³ is as defined above, and optionally equilibrating the siloxane resulting from hydrolysis.

The organohydrogenpolysiloxane (C) is compounded in an effective amount to induce curing of component (A). Preferably component (C) is used in such amounts that the molar ratio of SiH groups to vinyl groups in component (A) is from 0.1 to 4.0, more preferably from 1.0 to 3.0, and even more preferably from 1.2 to 2.8. A molar ratio of less than 0.1 may allow curing reaction to proceed little and make it difficult to produce cured silicone rubber. At a molar ratio in excess of 4.0, a substantial amount of unreacted SiH groups may be left in the cured composition which will change its rubber physical properties with the passage of time.

(D) Platinum Group Metal-Based Catalyst

The platinum group metal-based catalyst is compounded for inducing addition cure reaction to the inventive composition. Platinum, palladium and rhodium base catalysts are included. Of these, platinum base catalysts are preferred from the economical standpoint. Specific examples include H₂PtCl₆.mH₂O, K₂PtCl₆, KHPtCl₆.mH₂O, K₂PtCl₄, K₂PtCl₄.mH₂O, PtO₂.mH₂O, PtCl₄.mH₂O, PtCl₂, and H₂PtCl₄.mH₂O wherein m is a positive integer, and complexes thereof with hydrocarbons, alcohols and vinyl-containing organopolysiloxanes. They may be used alone or in admixture. The catalyst (D) may be used in a catalytic amount, specifically in an amount to give about 0.1 to 100 ppm of platinum group metal based on the weight of components (A) to (C) combined.

(E) Aluminum Compound

The aluminum compound, which may be either inorganic or organic, is a catalyst to promote polymerization between silanol and epoxy groups. Included are aluminum trihydroxide, aluminum alcoholates, aluminum acylates, aluminum acylate salts, aluminosiloxy compounds and aluminum chelates. The aluminum compound may be used in a catalytic amount, specifically in an amount of about 0.1 to 10% by weight, more preferably about 0.3 to 5% by weight based on the weight of components (A) and (B) combined. Less than 0.1 wt % of the aluminum compound may fail to provide a sufficient curing rate whereas more than 10 wt % may induce too fast cure, failing to manufacture a desired light-emitting semiconductor device.

In the epoxy-silicone mixed resin composition of the invention, an adhesive aid may be optionally added for improving the adhesion of the cured composition. Suitable adhesive aids are organosilicon compounds such as organosilanes and organopolysiloxanes having silicon atom-bonded alkoxy groups. Examples of the organosilicon compounds include alkoxysilanes such as tetramethoxysilane, tetraethoxysilane, dimethyldimethoxysilane, methylphenyldimethoxysilane, methylphenyldiethoxysilane, phenyltrimethoxysilane, methyltrimethoxysilane, methyltriethoxysilane, vinyltrimethoxysilane, allyltrimethoxysilane, allyltriethoxysilane, 3-glycidoxypropyltrimethoxysilane, and 3-methacryloxypropyltrimethoxysilane as well as siloxane compounds of straight chain or cyclic structure (i.e., organosiloxane oligomers) having about 4 to about 30 silicon atoms, especially about 4 to about 20 silicon atoms, as represented by the formula shown below.

In a preferred embodiment, organoxysilyl-modified isocyanurate compounds having the general formula (3) and/or hydrolytic condensates thereof (i.e., organosiloxane-modified isocyanurate compounds) are used as the adhesive aid. 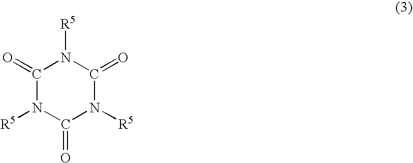
Herein R⁵ is an organic group having the formula (4): 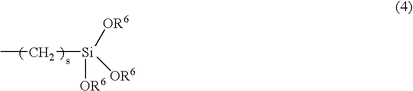
or a monovalent hydrocarbon group containing an aliphatic unsaturated bond, at least one of R⁵ is an organic group of formula (4), R⁶ is hydrogen or a monovalent hydrocarbon group of 1 to 6 carbon atoms, and s is an integer of 1 to 6, especially 1 to 4.

Examples of the monovalent hydrocarbon group containing an aliphatic unsaturated bond, represented by R⁵, include alkenyl groups of 2 to 8 carbon atoms, especially 2 to 6 carbon atoms, such as vinyl, allyl, propenyl, isopropenyl, butenyl, isobutenyl, pentenyl, hexenyl, and cyclohexenyl. The monovalent hydrocarbon groups represented by R⁶ include those of 1 to 8 carbon atoms, preferably 1 to 6 carbon atoms, for example, alkyl groups such as methyl, ethyl, propyl, isopropyl, butyl, isobutyl, tert-butyl, pentyl, hexyl and cyclohexyl, alkenyl groups such as vinyl, allyl, propenyl and isopropenyl, and aryl groups such as phenyl. Of these, alkyl groups are preferred.

Illustrative examples of the adhesive aid are given below. 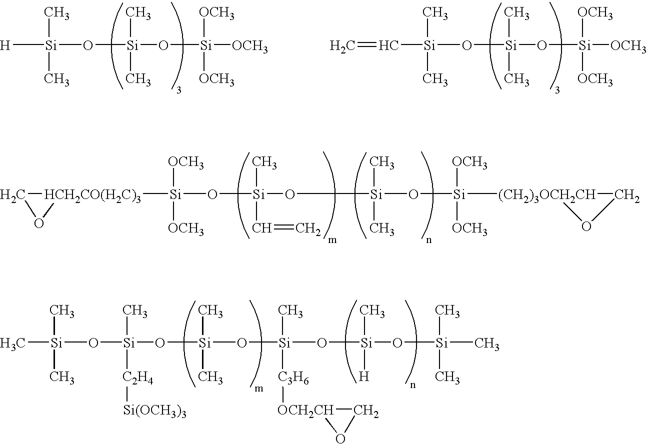
(Subscripts m and n are positive integers satisfying m+n=2 to 50, preferably 4 to 20.)

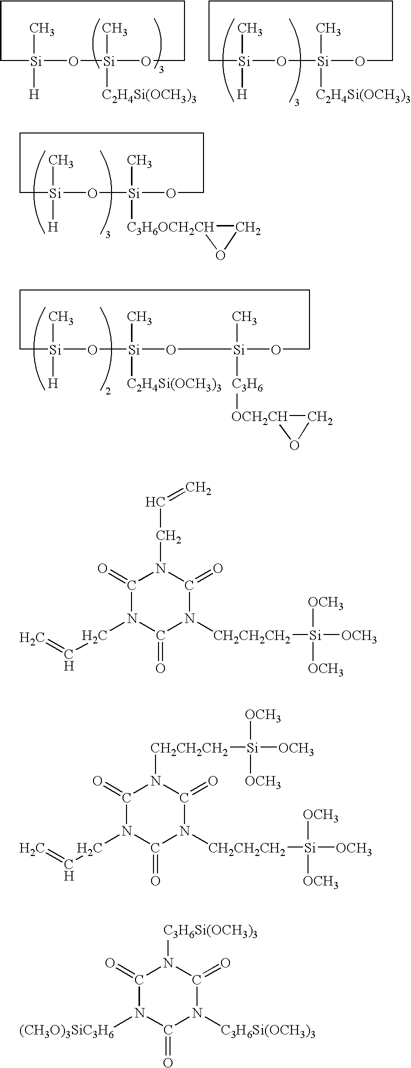

Of the organosilicon compounds, those organosilicon compounds having silicon atom-bonded alkoxy groups and silicon atom-bonded alkenyl groups or silicon atom-bonded hydrogen atoms (i.e., SiH groups) in a molecule are preferred because the cured compositions are more adhesive.

The adhesive aid, which is optional, may be included in an amount of up to about 10 parts by weight (i.e., 0 to 10 parts by weight), preferably about 0.01 to 5 parts by weight, more preferably about 0.1 to 1 part by weight, per 100 parts by weight of components (A) and (B) combined. Too less amounts of the adhesive aid may fail to achieve the desired effect whereas too much amounts may adversely affect the hardness and surface tack of a cured composition.

(F) Mold Release Agent

In the epoxy-silicone mixed resin composition of the invention, (F) an organic mold release agent is compounded. Suitable organic mold release agents include fatty acid derivatives commercially available from Riken Vitamin Co., Ltd. as Rikemar AZ-01, Rikemar B-100, Rikemar HC-100, Rikemar HC-200, Rikemar S-95, Rikemar S-200, Rikemar TG-12, Rikestar EW-100, Rikestar EW-200, Rikestar EW-250, Rikestar EW-400, Rikestar EW-440A, and Rikestar HT-10; polyethylene derivatives commercially available from Clariant Co. as LICOWAX PED 136, LICOWAX PED 153, and LICOWAX PED 371FP, and from Hoechst as HOE WAX PE 130 PDR, HOE WAX PED 191 PDR, HOE WAX PE 191 PDR, HOE WAX PE 191 Flakes, and HOE WAX PE 520 Powder; carnauba waxes commercially available from Toa Kasei Co., Ltd. as YTS-040625-03, Carnauba/Candelilla, and Refined Granular Carnauba; and montanic esters commercially available from Clariant Co. as LICOLUBU WE40. Inter alia, mold release agents in the form of fatty acid derivatives are excellent in compatibility with silicone resins, transparency after curing, and discoloration resistance upon high-temperature holding.

The organic mold release agent (F) is preferably added in an amount of 0.1 to 15% by weight, more preferably 0.2 to 15% by weight, and even more preferably 0.5 to 10% by weight based on the total weight of the composition.

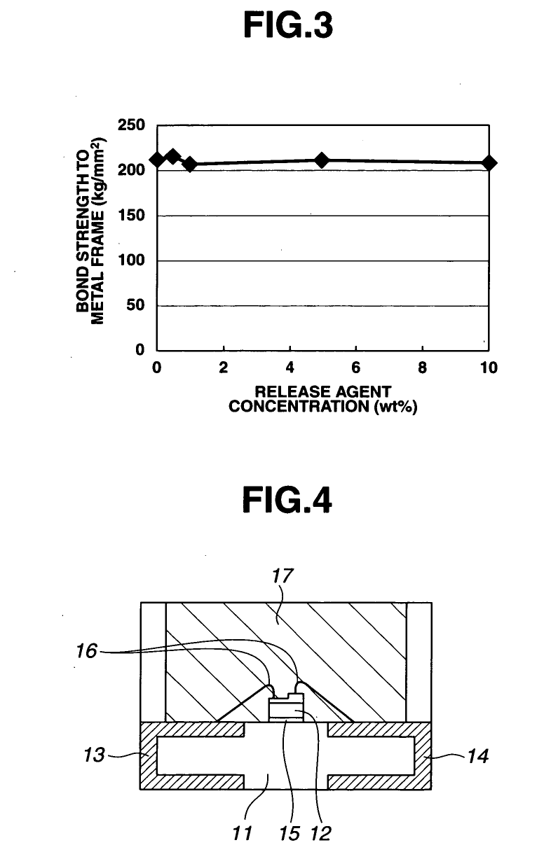

FIG. 2 relates to the adhesion to a metal mold of an epoxy-silicone mixed resin composition after mechanical molding therein and FIG. 3 relates to the adhesion to a metal frame of the same composition after mechanical molding and subsequent curing. The bond strength is measured while the concentration of the fatty acid-derived release agent in the composition varies over the range of 0 to 10 wt %. The graphs of FIGS. 2 and 3 are depicted by plotting the bond strength versus the release agent concentration.

The measurement data show that once the resin is mechanically molded and cured, the bond strength to metal frame remains substantially unchanged independent of the release agent concentration. However, as to the adhesion to metal mold of the mechanically molded resin, when the release agent concentration decreases below 0.1 wt %, the smooth removal effect of the release agent is suddenly lost, and the cured composition is observed to stick to the metal mold. If the release agent concentration exceeds 15 wt %, the composition has a light transmittance which is reduced due to the shielding effect of the release agent or the like, detracting from the luminosity of LED devices adapted to emit light outward. For this reason, the release agent should preferably be added in a concentration of 0.1 to 15% by weight.

The epoxy-silicone mixed resin composition of the invention can be readily prepared simply by mixing components (A) to (F) and optional components. Once the components are combined together, curing gradually takes place even at room temperature. It is then preferable to add minor amounts of reaction inhibitors such as acetylene alcohol compounds, triazoles, nitrile compounds or phosphorus compounds to the composition for extending the pot-life.

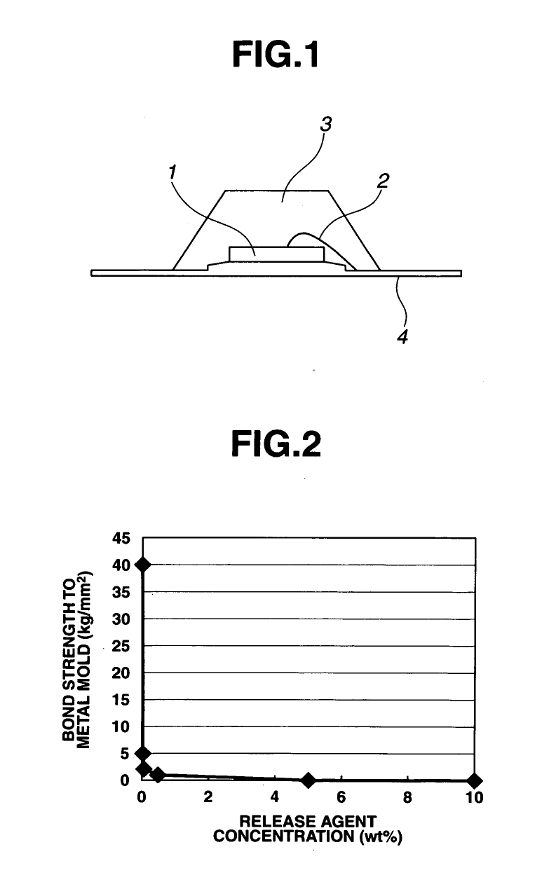

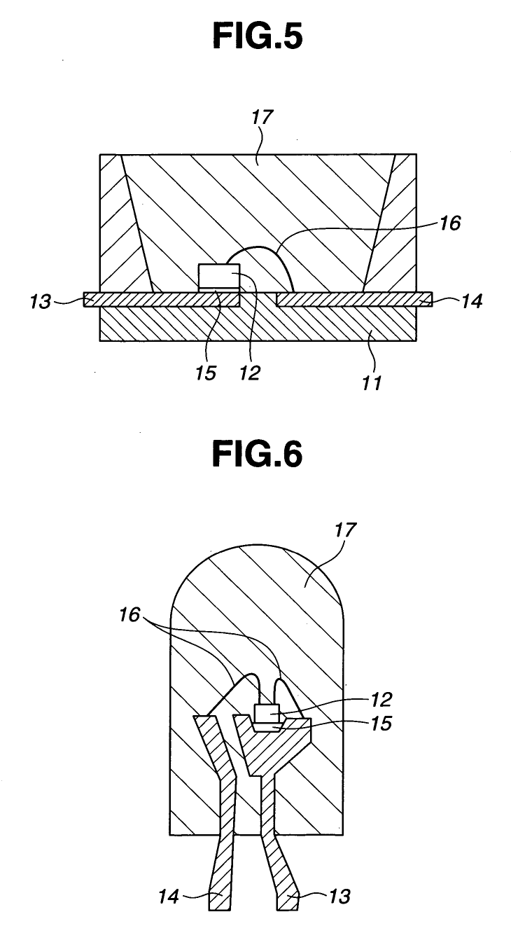

The epoxy-silicone mixed resin composition of the invention is used for the embedment and protection of light-emitting semiconductor members. The light-emitting semiconductor members to which the invention is applicable include light-emitting diodes (LED), organic electroluminescent devices (organic EL), laser diodes, and LED arrays. It is not critical how to encapsulate light-emitting semiconductor members. In a typical procedure, as shown in FIG. 1, the composition 3 is mechanically molded directly on an LED chip 1 disposed on a metal frame 4. In another procedure, as shown in FIGS. 4 and 5, a light-emitting semiconductor member is disposed in an open interior of a housing, the interior is filled with the embedding/protecting material so as to surround the light-emitting semiconductor member, and the material is cured. Also, as shown in FIG. 6, LED mounted on a matrix substrate may be encapsulated by a printing, transfer molding or injection molding process. Depicted in FIGS. 4 to 6 are a glass fiber-reinforced epoxy resin housing 11, a light-emitting semiconductor member 12, lead electrodes 13 and 14, a die bonding material 15, gold wires 16, and an embedding/protecting material 17.

For the inventive composition, the curing conditions may be selected from a wide range from about 72 hours at room temperature (25° C.) to about 3 minutes at 200° C. and in accordance with working conditions. An appropriate set of conditions may be determined by taking a balance with productivity and the heat resistance of a light-emitting semiconductor member and a housing. In the event of transfer molding, injection molding or compression molding, the cured product is obtained simply by molding at a temperature of 150 to 180° C. and a pressure of 20 to 50 kgf/cm² for a time of 1 to 5 minutes.

### EXAMPLE

Examples of the invention are given below by way of illustration and not by way of limitation. All parts are by weight. Me is methyl, Vi is vinyl, and Ph is phenyl.

### Examples 1 to 4

An epoxy-silicone mixed resin composition was prepared by combining 80 parts of a polysiloxane having formula (i), 20 parts of a bisphenol A epoxy resin, 5 parts of an organohydrogenpolysiloxane having formula (ii), 0.3 part of an adhesive aid having formula (iii), 0.05 part of an octyl alcohol-modified chloroplatinic acid solution, and 0.1 part of aluminum acetylacetone and intimately mixing them. To this composition was added 0.5 part of a fatty acid-derived 10 release agent (glycerin tri-18-hydroxystearate, Rikemar TG-12 by Riken Vitamin Co., Ltd.). Intimate mixing yielded a release agent-containing epoxy-silicone mixed resin composition of Example 1.

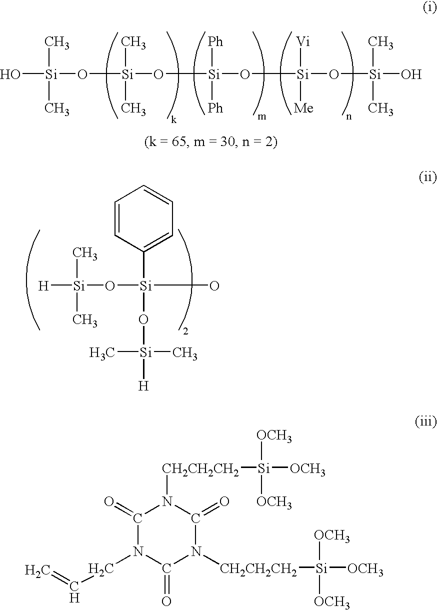

Compositions of Examples 2 to 4 were similarly prepared except that the amount of the release agent was changed to 1 part, 5 parts and 10 parts.

### Comparative Example 1

An epoxy-silicone mixed resin composition was prepared as in Example 1 except that the release agent was omitted.

### Example 5

An epoxy-silicone mixed resin composition was prepared by combining 80 parts of a polysiloxane having formula (i), 100 parts of a hydrogenated bisphenol A epoxy resin, 5 parts of an organohydrogenpolysiloxane having formula (ii), 0.3 part of an adhesive aid having formula (iii), 0.05 part of an octyl alcohol-modified chloroplatinic acid solution, and 0.1 part of aluminum acetylacetone and intimately mixing them. To this composition was added 1.0 part of a fatty acid-derived release agent (pentaerythritol tetrastearate, Rikestar EW-440A by Riken Vitamin Co., Ltd.). Intimate mixing yielded a release agent-containing epoxy-silicone mixed resin composition.

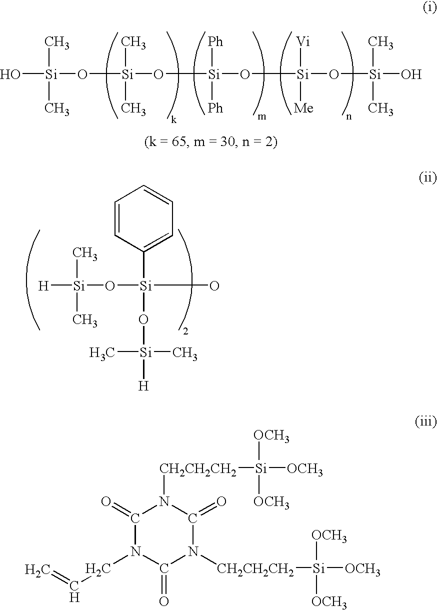

### Example 6

An epoxy-silicone mixed resin composition was prepared by combining 80 parts of a polysiloxane having formula (i), 100 parts of a hydrogenated bisphenol A epoxy resin, 5 parts of an organohydrogenpolysiloxane having formula (ii), 0.3 part of an adhesive aid having formula (iii), 0.05 part of an octyl alcohol-modified chloroplatinic acid solution, and 0.1 part of aluminum acetylacetone and intimately mixing them. To this composition was added 1.0 part of a fatty acid-derived release agent (mixed montanic esters, LICOLUBE WE40 by Clariant Co.). Intimate mixing yielded a release agent-containing epoxy-silicone mixed resin composition.

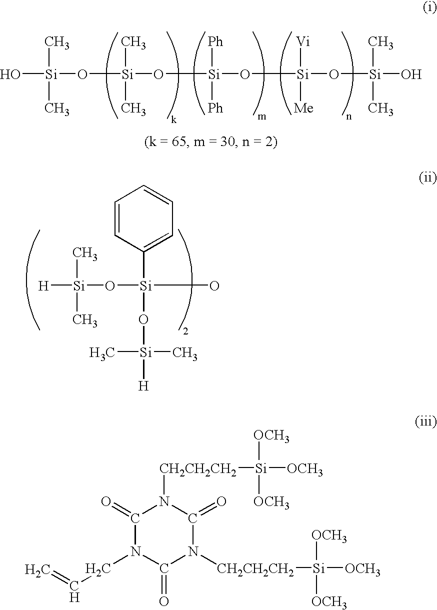

A light-emitting semiconductor device as shown in FIG. 1 was fabricated. An LED chip including an emissive layer of InGaN and having a main emission peak at 470 nm was used as a light-emitting member 1. The light-emitting member 1 was secured to a metal lead frame 4 by using a die-bonding material. Gold wires 2 were bonded to the light-emitting member 1 and the lead electrodes for electrical connection, completing a metal frame assembly. Using a molding machine equipped with a metal mold, and without applying an external mold release agent, the composition 3 was molded directly on the metal frame assembly for embedment and protection.

By continuous mechanical molding over 100 cycles, a series of LED devices were fabricated. They were visually observed for removal from the metal mold and the outer appearance of molded parts. To examine the adhesion of the resin to the metal frame, a thermal shock test of cooling to −40° C. and heating to 120° C. was performed 1,000 cycles on the device. The number of samples in which the resin peeled from the metal frame is reported as peeled samples/test samples. Also, light transmittance was measured before and after heating at 100° C. for 1,000 hours, calculating a retention from the initial.

The molded state and test results of Examples 1 to 6 and Comparative Example 1 are shown in Table 1. As seen from Table 1, Examples 1 to 6 allowed for smooth removal of molded parts from the metal mold even after 100 continuous molding cycles. By contrast, Comparative Example 1 prevented a molded part from being removed smoothly from the metal mold, and an LED device could not be fabricated. Then, an external mold release agent was applied on every molding cycle. The composition was mechanically molded, fabricating LED devices, which were subjected to the thermal shock test.

TABLE 1

| | | | | | | | Comparative |
|---|---|---|---|---|---|---|---|
| | Example | | | | | | Example |
| | 1 | 2 | 3 | 4 | 5 | 6 | 1 |
| 100 continuous molding cycles | possible | possible | possible | possible | possible | possible | impossible |
| Thermal shock test, peeled samples | 0/100 | 0/100 | 0/100 | 0/100 | 0/100 | 0/100 | 0/100 |
| Thermal shock test, cracked samples | 0/100 | 0/100 | 0/100 | 0/100 | 0/100 | 0/100 | 0/100 |
| Transmittance retention (%) @ 100° C./1000 hr heating | 90 | 90 | 90 | 90 | 90 | 90 | 40 |

The results of the thermal shock test show that for both the release agent-free composition of Comparative Example 1 and the release agent-containing compositions of Examples 1 to 6, no peel occurred. The incorporation of release agents in epoxy-silicone mixed resin compositions has no influence on the adhesion of the compositions to metal frames and ensures good heat resistance.

As seen from the results of light transmittance measurement, the compositions of Examples 1 to 6 showed no substantial drop of transmittance and maintained transparency whereas the composition of Comparative Example 1 experienced a substantial drop of transmittance due to the transfer of the external release agent to the cured composition.

Japanese Patent Application No. 2005-151200 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. An epoxy-silicone mixed resin composition comprising
(A) an organopolysiloxane having at least one vinyl or allyl group and at least one hydroxyl group per molecule,
(B) an organic resin having at least one epoxy group per molecule,
(C) an organohydrogenpolysiloxane,
(D) a platinum group metal-based catalyst,
(E) an aluminum compound, and
(F) an organic mold release agent,
the composition becoming transparent when cured.

2. The composition of claim 1 wherein the organic mold release agent (F) is present in an amount of 0.1 to 15% by weight based on the total weight of the composition.

3. The composition of claim 1 wherein the organic mold release agent (F) is a fatty acid derivative.

4. The composition of claim 1 which is used in injection molding, transfer molding or compression molding.

5. A transparent article obtained by curing the epoxy-silicone mixed resin composition of claim 1.

6. A light-emitting semiconductor device in which a light-emitting semiconductor member is encapsulated with a transparent cured product of the epoxy-silicone mixed resin composition of claim 1.
